(19) United States
(12) Patent Application Publication
(10) Pub. No.: US 2007/0226639 A1
(43) Pub. Date: Sep. 27, 2007

(54) System and method for providing dynamic media

(76) Inventor: George Eino Ruul, Applecross (AU)

Correspondence Address: CARR & FERRELL LLP, 2200 GENG ROAD, PALO ALTO, CA, 94303, US

(21) Appl. No.: 11/586,095

(22) Filed: Oct. 25, 2006

Related U.S. Application Data
(60) Provisional application No. 60/785,655, filed on Mar. 24, 2006.

(51) Int. Cl. G06F 3/00

(52) U.S. Cl. 715/765; 715/716

(57) ABSTRACT

Exemplary systems and methods for providing dynamic media are provided. In exemplary embodiments, the dynamic media comprises a media identifier configured to identify the dynamic media and a parent address configured to provide contact information for a media provider of the dynamic media. The media provider may provide the dynamic media based on the media identifier. The dynamic media may also be customized to a user.

### CROSS REFERENCE TO RELATED APPLICATION

The present application claims the priority benefit of U.S. Provisional Patent Application No. 60/785,655, filed Mar. 24, 2006 and entitled “Dynamic and Interactive Advertising System,” which is herein incorporated by reference. The present application is related to co-pending U.S. patent application Ser. No. ______ entitled “System and Method for Providing and Maintaining Dynamic Media,” U.S. patent application Ser. No. ______ entitled “System and Method for Transferring Media,” U.S. patent application No. ______ entitled “System and Method for Maintaining a History of Transferable and Updatable Media” all filed concurrently with the present application. The present application is further related to co-pending U.S. patent application Ser. No. 11/214,515 entitled “Managed E-Commerce Trading,” filed Aug. 29, 2005; U.S. patent application Ser. No. 11/250,996 entitled “E-Commerce with Direct Access to Real-Time Inventory,” filed Oct. 14, 2005; U.S. patent application Ser. No. 11/251,316 entitled “Managed E-Commerce Trading Environments,” filed Oct. 14, 2005; and U.S. patent application Ser. No. 11/258,419 entitled “Content Monitor,” filed Oct. 24, 2005, all of which are herein incorporated by reference.

### BACKGROUND OF THE INVENTION

1. Field of the Invention

Embodiments of the present invention relate generally to media and more particularly to dynamic media.

2. Description of Related Art

The Internet has developed into a dominant force in the global business market. Media such as movie clips, sound or music clips, articles, essays, recipes, advertisements, and advice columns may be posted by media providers for consumers to view. Businesses may now sell products, deal with vendors, post advertisements, promote items, and conduct other business activities via the Internet. For large businesses, frequently posting media to reach out to users is relatively easy. Smaller businesses, however, may not have the capability to do the same.

Typically, the media that a user sees while on particular websites are posted for a limited period of time. So if, for example, the user is too busy or not interested enough at the moment to investigate the media, the user may be unable to retrieve the media at a later time. For example, as Internet advertisements are frequently updated or changed by websites, it is often difficult for a user to find an advertisement that had been previously posted. Therefore, the media provider has lost a potential user or customer simply because the user can not find the media. Users may then go to another media provider when the user had more time or interest in the media.

An additional shortcoming of current online media is that the media can not customized to the user. If the user wants to see more relevant information regarding a particular media, the user may need to visit the media provider's website and search for the more relevant information. Alternatively, the user may go to a search engine and search for the relevant information, thus losing the potential user for the media provider without the customized media.

Therefore, there is a need for a dynamic media which may allow for customizable media.

Embodiments of the present invention provide systems and methods for providing dynamic media. In exemplary embodiments, the dynamic media comprises a media identifier configured to identify the dynamic media and a parent address configured to provide contact information for a media provider of the dynamic media. Communication may be triggered with the media provider associated with the parent address when the dynamic media is selected.

Via the communication, the media provider may provide the dynamic media based on the media identifier to a user. In some embodiments, the dynamic media may be customized to the user. The customization may be based on user preferences or past user behavior.

In other embodiments, the dynamic media may be dragged and dropped onto a device of the user. In these embodiments, the user selects the dynamic media and identifies a designated location where a copy of the dynamic media should be recreated. In some embodiments, the dynamic media may be customized to the user based on user preferences or past user behaviors.

### BRIEF DESCRIPTION OF THE DRAWINGS

FIG. 1 is an exemplary environment in which embodiments of the present invention may be practiced;

FIG. 2 is a block diagram of an exemplary core services server according to one embodiment of the present invention;

FIG. 3 is a block diagram of an exemplary user computing device;

FIG. 4 is a block diagram of an exemplary media engine;

FIG. 5 is a block diagram of an exemplary media provider computing device;

FIG. 6 is a block diagram of an exemplary media provider media engine;

FIG. 7A is a block diagram of an exemplary media;

FIG. 7B is an example advertisement; and

FIG. 8 is a flowchart of an exemplary method for obtaining a dynamic media.

### DETAILED DESCRIPTION OF EXEMPLARY EMBODIMENTS

Embodiments of the present invention provide an exemplary dynamic media system. In exemplary embodiments, dynamic media may be transferred to a user's computing device. The dynamic media may be customized according to user preferences and behaviors and current media provider information.

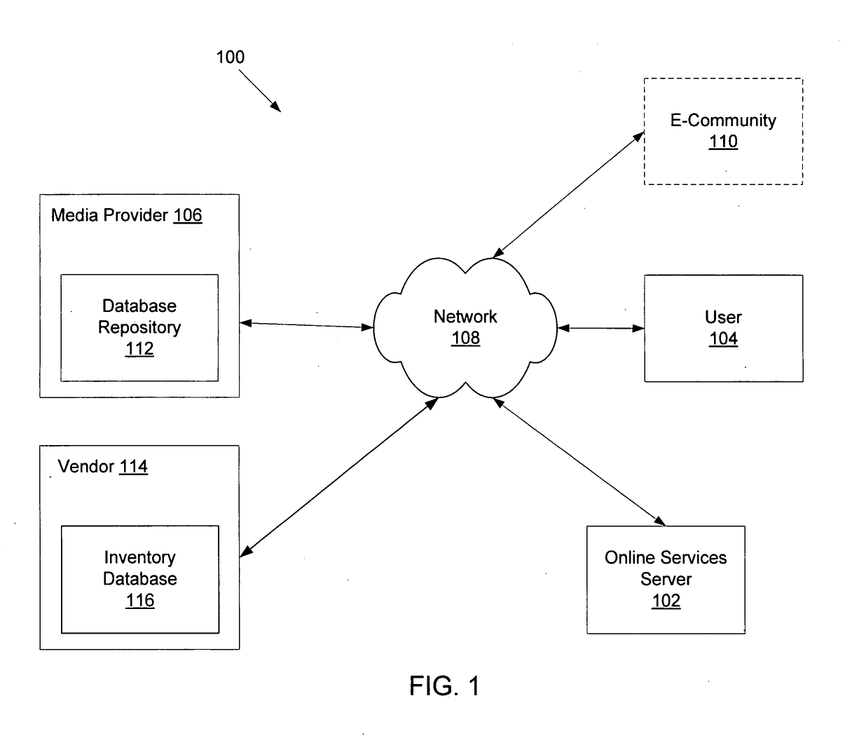

FIG. 1 shows an exemplary environment 100 in which embodiments of the present invention may be practiced. The environment 100 comprises an online services server 102, at least one user 104, and at least one media provider 106 all coupled for communication via a network 108. In exemplary embodiments, the network 108 may be the Internet, wide area network, local area network, or any other type of communication network. The online services server 102, a computing device of the user 104, and a computing device of the media provider 106 will be discussed in more detail below. In some embodiments, one or more optional e-communities 110 (i.e., groups of users sharing a common interest) may also be present in the environment 100.

The present environment 100 allows a plurality of users 104, media providers 106, and optional e-communities 110 to interact with each other. The interactions may result in online transactions or exchange of information. In the present embodiment, the media provider 106 provides dynamic media to the environment 100. The media provider 106 may comprise news outlets, content providers, marketing firms, advertising firms, or any entity which may manage online advertising and marketing strategies. The dynamic media may be presented, for example, on webpages, pop-ups, and banner ads. Additionally, the dynamic media may be presented in e-mail communications or shared between members of the environment 100 (e.g., users 104, media providers 106, and optional e-communities 110). Updates to the dynamic media may be provided via a database repository 112. In exemplary embodiments, the database repository 112 is a real-time database comprising up-to-the-minute data. The database repository 112 may also comprise a media database comprising different media the media provider 106 cam provide.

Dynamic media may comprise any item of information found on the network 108 that is configured to function with embodiments of the present invention. For example, the dynamic media may be an advertisement or news article that is identified as one that can function in the environment 100. The identifier may be a symbol or any other indicator that the media is operable in the environment 100.

In a specific embodiment, the media provider 106 is a vendor 114. In exemplary embodiments, the dynamic media from the vendor 114 (e.g., advertisement) is updatable with vendor information from a database repository comprising an inventory database 116. The exemplary inventory database 116 is a current, real-time database maintained by the vendor 114, which comprises inventory information including inventory amount and pricing. Typically, the inventory database 116 is located at the vendor's location and tracks pricing and movement of the vendor's inventory. In some embodiments, an advertisement provider may be coupled to the vendor 114 to provide the dynamic media on behalf of the vendor 114.

In exemplary embodiments of the present invention, the members of the environment 100 communicate over the network 108 using a specialized GUID-over-IP transport mechanism. The specialized transport mechanism allows the members to be coupled through a network of internal and external routers, proxies, and firewalls without requiring reconfiguration of various communications equipment. Routing management may be used to control pathways taken by communicating entities. Additionally, load balancing and N-tier construction allow for efficient scale out rather than scale up implementations.

The coupled computing devices of the members of the environment 100 each comprise a core services module which allows operation of embodiments of the present invention. The core services module will be discussed in more detail below.

In exemplary embodiments, the dynamic media is transferred to a designated location by selecting the dynamic media. In one embodiment, the selection is via a “drag and drop” command. “Drag and drop” as used herein may refer to selecting and moving a copy of the dynamic media to a designated location by generating a version of the transferred media at the designated location, generating a copy of the transferable media at the designated location, or creating a direct link to the transferable media at the designated location.

In exemplary embodiments utilizing a standard browser, when a dynamic media is selected, a script such as a Java script (e.g., a Visual Basic script) embedded into a HTML section of the dynamic media is activated (e.g., JAVA functions or active X control). This script interacts with the core services module at the user 104 device, which recognizes that the media is a dynamic media having a particular media identifier and a parent identifier. A connection is then made via the script and the core services module to the media provider 106 identified by the parent identifier, which can then provide instructions and data to display a version of the dynamic media at the user 104 device. The data may allow for an exact duplicate of the dynamic media the user 104 selected or a customized version of the dynamic media. While the result may appear to be a “drag and drop” in these embodiments, in reality, it is an instruct and recreate process. In a further embodiment, the dynamic media as displayed on a web page, for example, is extracted and utilized to display the dynamic media on the user's desktop, even if the user is offline at that time. However, any action based on a real time link is curtailed until reconnection occurs.

In embodiments utilizing an online services application, a version of the dynamic media can be “copied and pasted.” That is, every component that is embedded in the dynamic media can be copied and moved over to the designated location.

In yet further embodiments, the media may literally be “dragged and dropped” from a first location to a second location (i.e., taken from the first location and dropped onto a second location). For example, a media may be dragged from the desktop of the user 104 to an e-mail to be sent to another user. In these embodiments, the trigger or select event is a “drag and drop” command received from the user 104.

While some of the above embodiments describe a media constructed in, or containing at least a section of, HTML, alternative embodiments of the media may be constructed using other formats. For example, the media may be constructed using Macromedia's Flash, XML using XSLT, or any other potential construct language that can trigger the select event. The “select” event may cause the media to be transferred, copied, or dropped, or may cause a connection to the media provider 106 to be established.

It should be noted that the environment 100 of FIG. 1 is exemplary. Alternative embodiments may comprise more or fewer components. For example, more than one online services server 102 may be provided (e.g., regionally based). Furthermore, any number of users 104, media providers 106, e-communities 110, vendors 114, and advertisement providers may be coupled in communication in the environment 100 at any time.

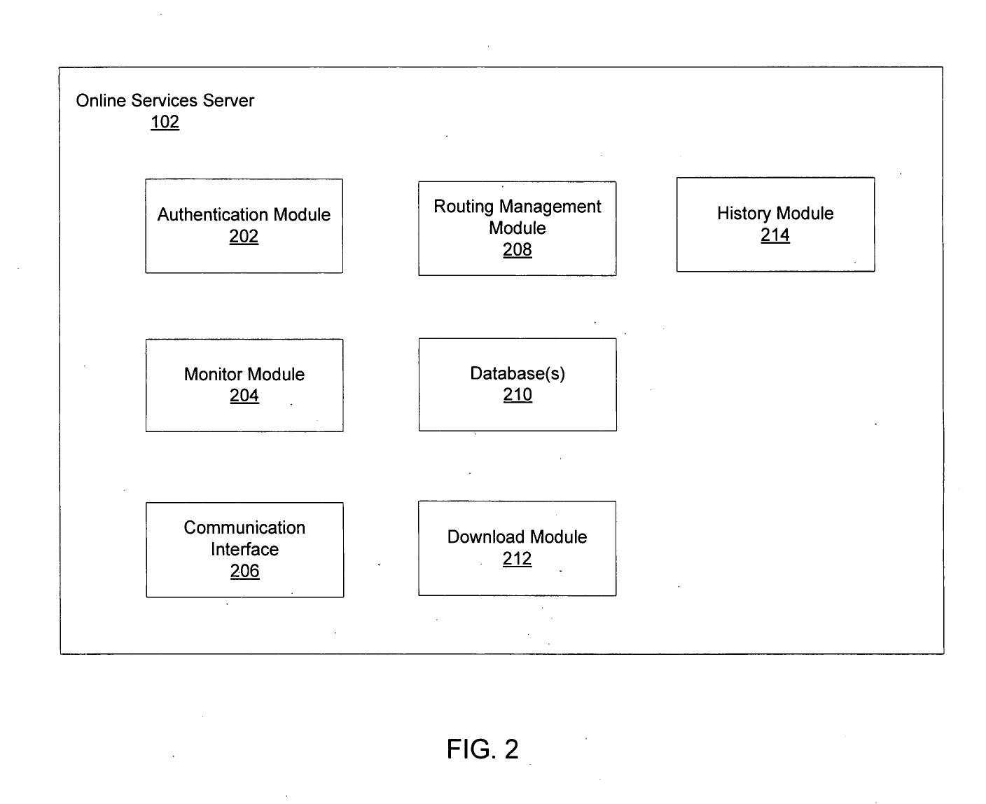

Referring now to FIG. 2, the exemplary online services server 102 is shown in more detail. The online services server 102 comprises an authentication module 202, a monitor module 204, a communication interface 206, a routing management module 208, database(s) 210, a download module 212, and a history module 214. In some embodiments, the database(s) 210 comprises a plurality of databases, each storing designated data. For example, the online services server 102 may comprises an authentication database (e.g., containing user 104 and media provider 106 information), a monitor database (e.g., storing transaction information), an history database (e.g., storing media tracking information), and an online services application database (e.g., storing e-commerce plug-ins and modules for e-commerce, e-community, or other applications that may be accessed and downloaded onto the user 104 and vendor 114 devices). In alternative embodiments, the database 210 is located outside of the online services server 102 but is coupled thereto. It should be noted that the online services server 102 may comprise other components not relevant to the functionalities of embodiments of the present invention.

The exemplary authentication module 202 authenticates users 104, media providers 106, e-communities 110 (e.g., an administrator for the e-community 110), and vendors 114. When these members first register with the online services server 102, the members provide data such as a user name, password, and contact information. This information is then stored in the database(s) 210.

Subsequently, authentication may occur seamlessly and unobtrusively to the members. In one embodiment, the authentication process comprises verifying the user name and password supplied by the member with those stored in the database(s) 210. Alternative methods for authenticating members may be utilized, such as, for example, verifying IP addresses in communications sent between members. The authentication information may be received via the communication interface 206. The authentication module 202 then compares the received authentication information to authentication information stored in the database(s) 210. As such, members accessing and utilizing the environment 100 are know to the online services server 102, and based on permissions associated with the member, are enabled to interact with other members. In some embodiments, the authentication module 202 allows for transfer of dynamic media.

In alternative embodiments, the authentication module 202 is optional or not required in order for embodiments of the present invention to be practiced. In these embodiments, a user 104, media provider 106, e-community 110, and/or vendor 114 does not need to be registered/authenticated in order to support dynamic media functionalities. For example, registration/authentication may be performed automatically without the user 104 being required to submit any personal information. In these embodiments, each dynamic media is an instantiation of a node of a closed/private community comprising the media provider 106 and all dynamic media (from the media provider 106) currently in existence. The media provider 106 hosts the ‘authentication process’ and it may be different for each dynamic media accessed by the user 104. Thus, an instantiation is authenticated each time as distinct from the user 104 or computing device, itself.

As such, the authentication process may occur during an initial connection with the system (e.g., login at a start of a session). In alternative embodiments, authentication may occur at other times, such as when the user 104 interacts with a dynamic media. In further embodiments, the user 104 does not need to be authenticated or logged into the online services server 102 in order to interact with the dynamic media (e.g., view, transfer, or receive updates to the dynamic media).

In some embodiments, authentication of the user 104 allows for customization of dynamic media viewed by the user 104. Because the user 104 is now logged in with the online services server 102 and/or the media provider 106, updates from the media provider 106 may be provided to the authenticated user 104. Additionally, the online services server 102 may monitor dynamic media viewed by each user 104 and track actions associated with each user 104 with regards to dynamic media (e.g., transferring a dynamic media to other users 104, purchasing via the dynamic media, etc.). The monitored data may then be used by the dynamic media provider 106 to target future media to the user 104.

In some embodiments, the monitor module 204 monitors interactions with dynamic media. Interactions with dynamic media may comprise, but are not limited to, viewing a dynamic media, transferring the dynamic media onto the user's local computing device, transferring the dynamic media to another user 104, purchasing a product shown in the dynamic media, and so forth. All of these interactions may be tracked by the monitor module 204. For example, the online services server 102 may receive or intercept communications containing a copy of the dynamic media being sent between users 104. The monitor module 204 can then update the database(s) 210 with the tracking information.

The routing management module 208, in one embodiment, provides routing instructions that allow for control of pathways taken, for example, by communications containing transferred copies of the dynamic media. In one embodiment, the use of these routing instructions allows the online services server 102 (via the monitor module 202) to monitor the communications by routing a copy of the communication containing the copy of the dynamic media being transfer to the online services server 102.

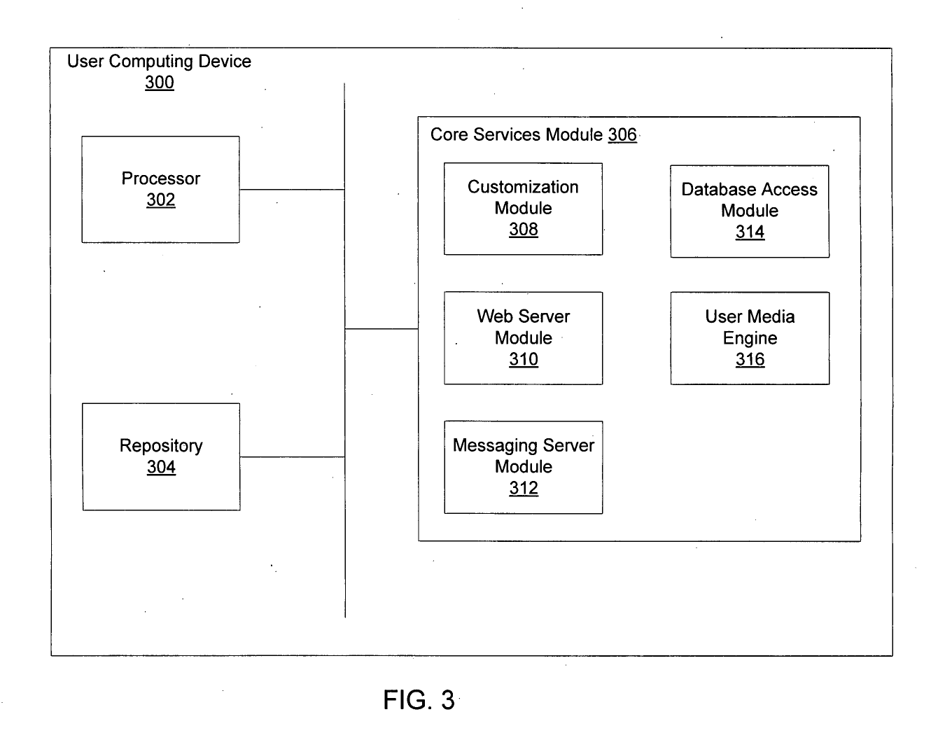

The exemplary download module 212 provides applications and/or components which create core services modules, as described in more detail in connection with FIG. 3, at the device of the user 104, the media provider 106, e-community 110, and the vendor 114. In alternative embodiments, components of the download module 212 may be embodied, for example, on a CD-ROM for easy distribution. The download module 212 may provide a license agreement, registration, and product updates. In some embodiments, the download module 212 will distinguish a downloading member as a user 104, the media provider 106, e-community 110, and the vendor 114, so as to provide a different version of the core services module component to each type of member. In some embodiments, the core services module components may be the same for all members, while alternative embodiments may comprise different components. Once downloaded by the member, the core services module is configured to meet the needs of the downloading member.

An optional history module 214 may be provided in the online services server 102. In certain embodiments where a history database is maintained at the online services server 102, the history module 214 is configured to maintain a history table for each media it tracks and reproduce the history table for viewing. The history module 214 may also generate an updated media identifier or part of an updated media identifier, as discussed herein, when a new media status is received from the user 104. In alternative embodiments, the history database and the history module 214 are located at the vendor 114 or media provider 106. In yet a further embodiment, the functions of the history module 214 may be performed by the monitor module 204.

Referring now to FIG. 3, an exemplary user computing device 300 is shown. The user device 300 is operated by a user 104 to access the network 108 and other members of the environment 100. The user computing device 300 may comprise a laptop, mobile phone or device, or any other wired or wireless computing/digital device that is network enabled to receive information via the network 108. In exemplary embodiments, the user computing device 300 comprises a processor 302, a repository 304 or other storage medium, and a user core services module 306 which may be stored in memory or in the repository 304. Alternative embodiments of the user computing device 300 may comprise more, less, or functionally equivalent components. For example, the user computing device 300 may comprise other components not necessary for functionalities of embodiments of the present invention.

In some embodiments, the user core services module 306 is downloaded from the online services server 102 via the download module 212 and is seamlessly integrated into the user computing device 300. In exemplary embodiments, the core services module 306 is downloaded when an online services application is downloaded. For example, the core services module 306 is downloaded when a user 104 downloads an e-commerce application or an e-community application as described in related U.S. patent application Ser. No. 11/214,515 entitled “Managed E-Commerce Trading,” and U.S. patent application Ser. No. 11/251,316 entitled “Managed E-Commerce Trading Environments,” which are incorporated by reference. That is the core service module 306 is an inherent part of all online services applications provided by the online services server 102. Once the core services module 306 is installed on the user computing device 300, regardless of whether an online services application is running, interaction with dynamic media is enabled. In some embodiments, the running of an online services application will enable further functionalities of the dynamic media, such as the “drag and drop” function. In alternative embodiments, the core services module 306 may be downloaded separate from any online services application (e.g., when the user 104 first interacts with a dynamic media).

The core services module 306 may comprise a customization module 308, a web server module 310, a messaging server module 312, a database access module 314, and a user media engine 316. In some embodiments, the core services module 306 may also comprise a specialized browser technology optimized for communication using the Internet without depending on existing HTML/XML browser technology.

In exemplary embodiments, the customization module 308 maintains and updates user preferences. Preferences may include preferred media providers 106 and vendors 114, past purchase preferences, and so forth. The preferences may also include information received directly from the user 104 via, for example, a survey or other data collection methods. Additionally, the customization module 308 may determine preferences based on dynamic media that the user 104 has interacted with (e.g., transferred onto their desktop), viewed, purchased from, transferred to other users 104, or received from other users 104. These preferences may be stored in a database in the repository 304.

The exemplary web server module 310 is configured to allow web-based interactions with other system installations. Additionally, the web server module 310 may include messaging or Voice-over Internet Protocol (VoIP) technology.

The exemplary messaging server module 312 is configured to ensure robust communication with other members. In one embodiment, the messaging server module 312 receives and processes a command from the user 104 to transfer a copy of a dynamic media to another user 104. Additionally, the messaging server module 312 may provide communication to the media provider 106 via e-mail or a link associated with the dynamic media, as will be discussed in more detail below.

In some online services application enabled embodiments, the database access module 314 provides access to real-time information and updates in the media provider's database repository 112 or vendor's inventory database 116 such as updated news, directory information, inventory, pricing, and the like. This information may be used by the user media engine 316 to update dynamic media to reflect remaining inventory or pricing, for example. In alternative embodiments, the data access module 314 is optional or not required.

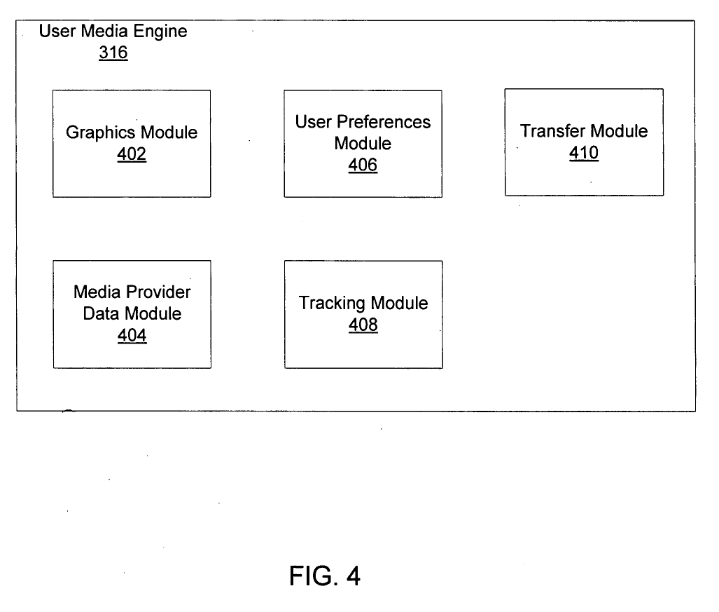

The user media engine 316, which is described in more detail in connection with FIG. 4, is configured to facilitate interactions of the user 104 with the dynamic media, including viewing, transferring, and locally storing the dynamic media.

Referring now to FIG. 4, a block diagram of the exemplary user media engine 316 is shown. In various embodiments, the user media engine 316 may facilitate the transfer of dynamic media onto the user's desktop, customization of the dynamic media, and/or transfer of the dynamic media to other users 104. The media engine 316 may comprise a graphics module 402, media provider data module 404, user preference module 406, tracking module 408, and transfer module 410. In alternative embodiments, the media engine 316 may comprise more, less, or functionally equivalent modules.

The exemplary graphics module 402 processes data (e.g., received from the media provider 106 associated with a selected dynamic media) in order to generate a graphic of the dynamic media at a designated location on the user computing device 300. The data may comprise the graphical data for some or all of the dynamic media.

The exemplary media provider data module 404 is configured to interact with the media provider 106 in order to customize the dynamic media. According to exemplary embodiments, the dynamic media is customized by the media provider 106 based on user preferences. In some embodiments, the selection of a dynamic media (e.g., “drag and drop” or activation of a link on a dynamic media) acts as a trigger for the media provider data module 404 to communicate user preferences, which may include past behavior, to the media provider 106 in order to receive a copy of the dynamic media that has been customized to the user 104. Alternatively, the media provider 106 may request the user preference information from the media provider data module 404. The media provider data module 404 may transmit a list of preferences from the user preferences module 406 which the media provider 106 processes to generate a customized version of the dynamic media. The dynamic media is then received by the media engine 316 (e.g., via the media provider data module 404) for display. For example, if a user has purchased a travel package to Europe from the media provider 106 in the past, the media provider data module 404 may send this past behavior information to the media provider 106. The media provider data module 404 may then receive data limited to a selection of books within a European travel genre in a customized version of the selected dynamic media.

In alternative embodiments, the media provider data module 404 receives or obtains data from the media provider 106 and merges the data with the static data. In some embodiments, the media provider data module 404 may select data from a larger set of data received from the media provider 106. For example, if a user's language preference is Spanish, the media provider data module 404 may select a Spanish-language version of the media instead of an English version. The selected data is then merged with the static data to generate the customized version of the dynamic media at the user computing device 300.

In other embodiments, the media provider data module 404 may receive a link to a copy of the dynamic media from the media provider 106. As such, no actual version of the dynamic media (e.g., media data) may be received by the user 104. The link may comprise an HTML address or a feed such as an RSS feed, an Atom feed or the like. In these embodiments, when the user clicks or otherwise activates the link, the media provider data module 404 communicates with the media provider 106 to facilitate display of a version of the dynamic media to the user 104.

In customizable media embodiments, the user preferences module 406 accesses the list maintained by the customization module 308 (FIG. 3) to determine one or more user preferences which may be sent to the media provider 106 or incorporated with the static media data. For example, a user's geographic location may be used to display a map to the nearest store of the vendor 114. In a further example, the user's geographic location may be used to obtain local pricing information from the vendor 114. In this example, the user preference module 406 works with the media provider data module 404 to obtain the pricing information from the inventory database 116.

In alternative embodiments, the dynamic media may not be customized to the user 104. In these embodiments, the data received by the media provider data module 404 is comprised of static media data, and the user preference module 406 is not required.

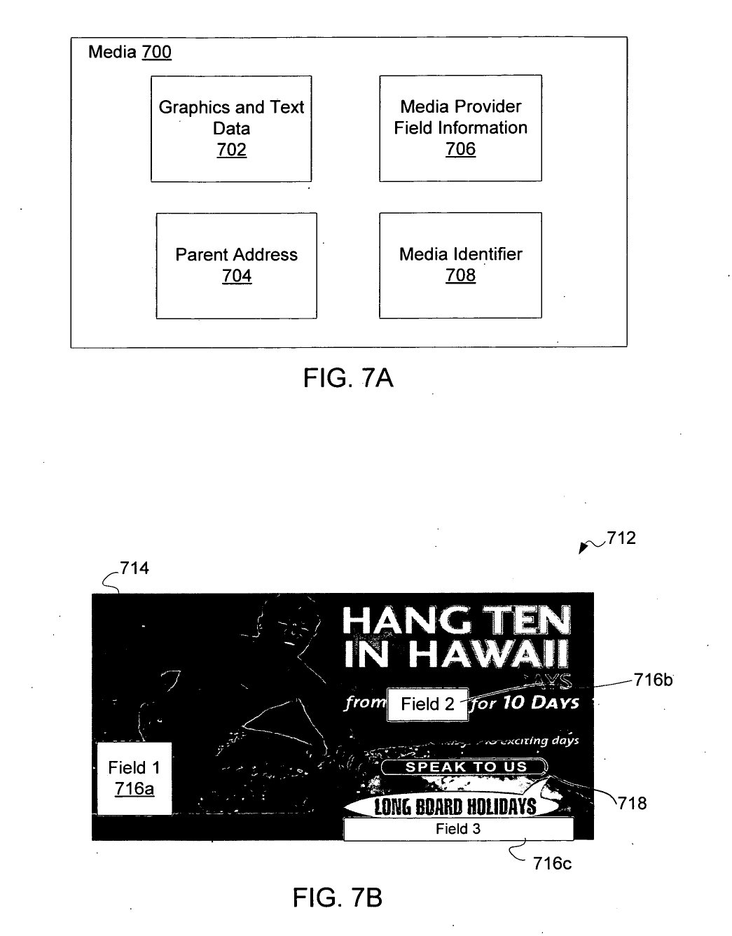

The exemplary tracking module 408 maintains a history of one or more dynamic media that interacts with the media engine 316 (e.g., transferred, viewed, etc.). After each subsequent update, customization, or transfer of the dynamic media, the tracking module 408, in some embodiments, transmits data related to the update, customization, and/or transfer of the dynamic media to a database (e.g. database 210 of FIG. 2, a database in the repository 304 of FIG. 3, and/or a database at the vendor 114 or media provider 106 associated with the dynamic media). The tracking module 408 may also create a new media identifier each time the dynamic media changes or is transferred. Media identifiers will be discussed in detail in connection with FIG. 7A and FIG. 7B.

The exemplary transfer module 410 manages movement of dynamic media. For example, when the dynamic media is first dragged and dropped onto the desktop, the transfer module 410 may receive media data from the media provider 106 and an indication of a location on the desktop where a copy of the selected dynamic media should be placed after generation by the graphics module 402 (e.g., dragged from the webpage or other location and dropped at the location on the desktop). The transfer module 410 may also aid the media provider data module 404 to communicate with the parent of the dynamic media. In further examples, the transfer module 410 transfers copies of selected dynamic media to e-mail communications or websites, for example, so that the user 104 may share the dynamic media with others.

In alternative embodiments, more, less, or functionally equivalent modules may comprise the user media engine 316. For example, the user preferences module 406 and/or the media provider data module 404 may be functionally combined with the graphics module 402 to form a single module. Furthermore, the media provider data module 404 and user preference module 406 may be optional.

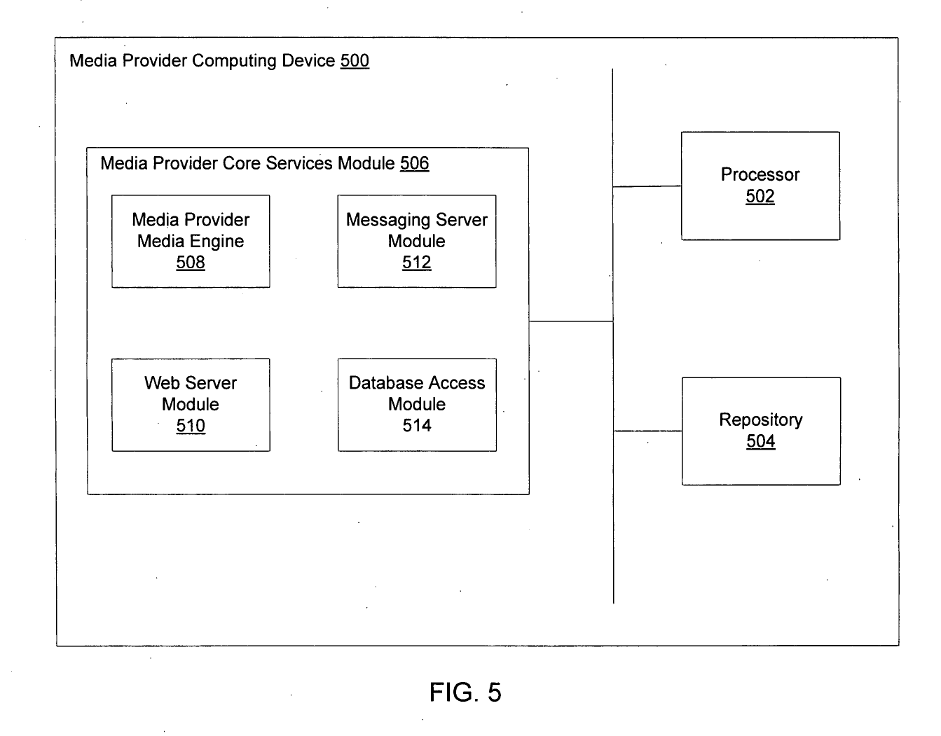

Referring now to FIG. 5, an exemplary media provider computing device 500 is shown. The media provider computing device 500 may be similar to the user computing device 300 of FIG. 3 and the functionalities of same named components may also be similar. The media provider computing device 500 may comprise a processor 502, a repository 504 or other storage medium, and a media provider core services module 506, which may be stored in memory.

In exemplary embodiments, the media provider core services module 506 is downloaded from the online services server 102 via the download module 212 and is seamlessly integrated into the media provider's computing device 500. Similar to the user core services module 306, the media provider core services module 506 may be downloaded when an online services application is downloaded from the online services server 102. For example, the media provider core services module 506 may be downloaded when the media provider downloads an e-commerce application. Alternatively, the core services module 506 may be downloaded separate from the online services application.

The media provider core services module 506 may comprise a media provider media engine 508, a web server module 510, a messaging server module 512, and a database access module 514. In some embodiments, the core services module 506 may also comprise a specialized browser technology optimized for communication using the Internet without depending on existing HTML/XML browser technology. The media provider computing device 500 shown in FIG. 5 is exemplary and may comprise other components not functionally related to embodiments of the present invention.

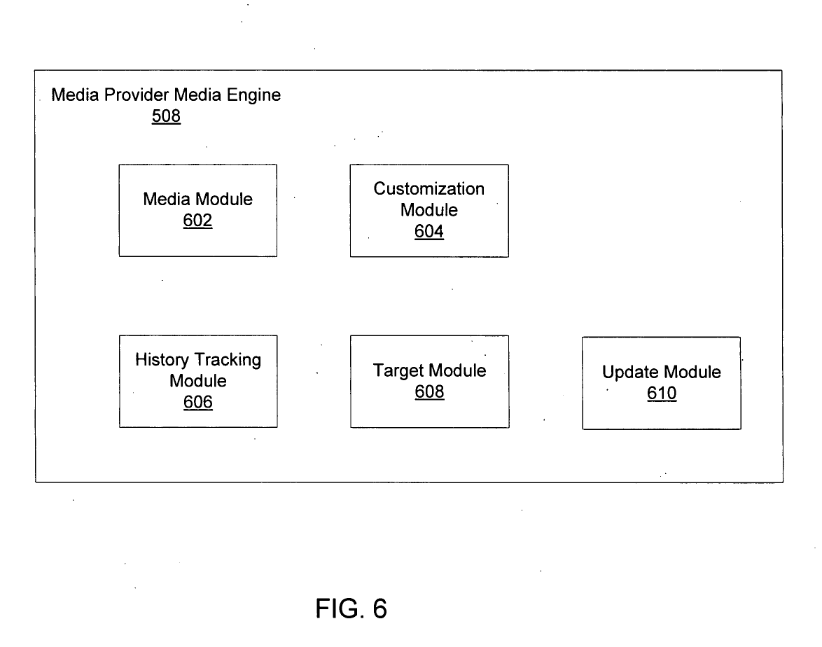

The media provider media engine 508, which is described in more detail in connection with FIG. 6, is configured to provide dynamic media to a requesting user 104. The dynamic media may be customized to the user 104 or updated as real-time information is incorporated into the dynamic media and forwarded to the user 104.

The exemplary web server module 510 is configured to allow web-based interactions with other system installations. Additionally, the web server module 510 may include messaging or Voice-over Internet Protocol (VoIP) technology.

The exemplary messaging server module 512 is configured to ensure robust communication with other members. The messaging server 512 may provide communication to the users 104, for example, via e-mail or a link associated with the dynamic media, as will be discussed in more detail below.

In some embodiments, the database access module 514 provides access to real-time information and updates in the media provider's own database repository 112 (e.g., repository 504) such as updated news, directory information, inventory, pricing, and the like. This information may be used by a customization module in the media provider media engine 508 to update dynamic media as will be discussed in more detail in connection with FIG. 6.

FIG. 6 illustrates the media provider media engine 508 in more detail. The media provider media engine 508 may comprise a media module 602, a customization module 604, a history tracking module 606, a target module 608, and an update module 610.

The media module 602 provides the selected dynamic media to the user 104. In exemplary embodiments, the media provider media engine 508 receives a request for a dynamic media from the user 104. The request may be via the messaging server 512, for example. Based on a media identifier of the requested dynamic media, the media module 602 provides a version of the dynamic media to the user 102 by sending data necessary for the recreation of the version of the dynamic media at the user computing device 300.

In some embodiments, the version of the dynamic media is customized. The customization module 604 provides the data to customize the dynamic media. In exemplary embodiments, the customization module 604 may send instructions to the user preference module 406 to provide user preferences. In some embodiments, user preference information may then be received from the user preference module 406 or the media provider data module 404. Based on the user preference information, the customization module 604 will create a version of the dynamic media that will be customized to the user 104. For example, if the user preference information indicates that the user 104 is located in California, the customization module 604 takes that information and determines data to include in the dynamic media which is specific to California (e.g., include sales tax information in price or provides local travel packages that are on sale). In alternative embodiments, the user preference information may be sent with the initial request for the dynamic media or at any time after the version of the dynamic media is received from the media provider 106.

In some embodiments, the customization module 604 may also determine if the media provider 106 has updated information for the dynamic media. In exemplary embodiments, the customization module 604 may, via the database access module 514, access a database in the database repository 112 (e.g., repository 504) and determine if updated information is available for the select dynamic media. For example, a current temperature may have changed, and the customization module 604 may push this updated information to the user 104 in an update (e.g., a new version of the dynamic media or data that will update the existing version of the dynamic media at the user computing device 300). In these embodiments, the update module 610 is optional or not required.

The history tracking module 606 is configured to allow the media provider 106 to track versions of their dynamic media with the users. The history tracking module 606 may also track other interactions performed by the user with respect to their dynamic media. Tracking allows the media provider 106 to determine effective media for the user 104. If the user 104 has, for example, consistently selected certain dynamic media from the media provider 106 or purchased products via some dynamic media, the media provider 106 can track these interactions and offer customized dynamic media to the user. Thus, based on the user's past behavior, future media can be customized and, in some embodiments, pushed to the user 104. The pushed media can replace expired versions of dynamic media on the user computing device 300 or may be offered to the user 104, for example, via e-mail or via the media provider's website the next time the user 102 visits the website. In some embodiments, the history tracking module 606 is optional or not required.

The target module 608 is configured to provide targeted dynamic media to the user 104. In exemplary embodiments, the target module 608 compiles a list of dynamic media which the media provider 106 wants to “push” to users 104. The target module 608 works with the customization module 604 to assess and review user preferences and past behavior of users 104. The selected users 104 may currently have versions of the media provider's media on their user computing device 300 or have, in the past, interacted with the media provider 106. Relevant dynamic media may then be provided to the users 104. The relevant dynamic media may be customized to the user 104, according to some embodiments.

The exemplary update module 610 determines if any dynamic media from the media provider 106 should be updated or replaced. In exemplary embodiments, the update module 610 monitors the database repository 112 for changes that may trigger an update to dynamic media. In these embodiments, the update module 610 may check the database repository 112 for updates at predetermined times. If an update is available, the update module 610 triggers the media module 602 and the customization module 604 to generate and provide the updated dynamic media to the user 104. The updated dynamic media may also be provided to other locations on the network 108 (e.g., on the media provider's website).

Referring now to FIG. 7A, a block diagram of an exemplary dynamic media 700 is shown. A version of the dynamic media 700 can be “dragged and dropped” onto the user's 104 desktop or transferred to another user. Although the dynamic media 700 may not actually be dragged from one location and dropped on a second location, the operation of the various components of the core services modules 306 and 506 function to make it appear as a simple “drag and drop” operation.

In some embodiments, the version of the dynamic media 700 may additionally be customized to the user preferences or updated as the media provider's database changes. In exemplary embodiments, the dynamic media 700 (or version of the media 700) comprises graphics and text data 702, a parent address 704, optional media provider field information 706, and a media identifier 708.

In non-customizable media embodiments, the exemplary graphics and text data 702 may comprise data for the entire dynamic media. That is, the graphics and text data 702 is all that is required in order to locally generate the dynamic media for display.

In customizable media embodiments, the exemplary graphics and text data 702 comprises data for parts of the dynamic media 700 that are static (i.e., not customized or updated). The static data may include the media provider's logo, fixed text or images, and dimensions of the dynamic media 700. Furthermore, the graphics and text data 702 may include metadata about fields in which the optional media provider field information 706 is merged for a customizable dynamic media.

The parent address 704 is an identifier indicating a media provider 106 and contact information for the media provider 106. As previously discussed, the media provider 106 may be a news provider, an online magazine or website, vendor 114, or other publisher of online content. When the dynamic media is selected for transfer, the user media engine 316 may relay a message to the media provider 106 using the parent address 704 so that the dynamic media can be received, updated, or customized to the recipient.

The optional media provider field information 706 comprises information transferred to the user 104 from the media provider 106. The media provider field information 706 includes information used to customize or update the version of the dynamic media 700 when the dynamic media 700 is dragged and dropped to the user 104 or transferred to another user. The media provider field information 706 can be transferred with the dynamic media 700. In an alternative embodiment, a set of field information may be transferred with the version of the dynamic media 700. The media provider data module 404 may then select the field information 706 from the set according to the user preferences as discussed herein.

The media identifier 708 is used to identify a specific version of the dynamic media 700 that the user 104 views due to customizing or updating of the dynamic media 700. The tracking module 408 may use the media identifier 708 to maintain a history of the dynamic media 700. The media identifier 708 may also change, for example, when the dynamic media 700 is dragged and dropped by the user 104 and when the dynamic media 700 is received by another user after being transferred.

Referring now to FIG. 7B, an example dynamic media 712 is shown. In the present example, the dynamic media 712 is an advertisement for a Hawaiian vacation. The graphics and text data 702 is shown as media body 714 having optional fields 716 and an optional link 718. The media body 714 has a length dimension and a width dimension dictated by the graphics and text data 702. The graphics and text data 702 may also include image, text, and designated locations and dimensions for optional fields 716. In one embodiment, the graphics and text data 702 comprises the entire dynamic media.

The media body 714 may also comprise an optional link 718 configured to activate a communication interface (not shown) when a user 104 clicks on the link 718. The link 718 provides an alternate way to contact a media provider 106. For example, when the user 104 clicks the link 718, a real-time interaction with the media provider 106, such as through online messaging or VoIP, may be provided.

In further embodiments, the optional fields 716 are components of the dynamic media 712 that may be updatable or customizable. In customizable media embodiments, after the dynamic media 712 is selected or received by the user 104, these fields 716 are customized to the user 104. Additionally, as inventory, pricing, or other information changes, some of these fields 716 may be updated. The fields 716 may each display a piece of field information 706 according to metadata associated with each field, in some embodiments. For example, field 1, 716a, may display special promotions or remaining inventory in the vendors' inventory database 116. Field 2, 716b, may display price information. In exemplary embodiments, the price information is a current price as obtained from the vendor's inventory database 116. Finally, field 3, 716c, may display vendor contact information.

The fields 716 may be used for different information in other types of dynamic media 700. For example, recipes may include fields 716 to indicate low fat or low sugar variations. News stories may add fields 716 as news events develop to provide continuous coverage of events or a local perspective. Any number of fields 716 may be embodied in the sample media 712.

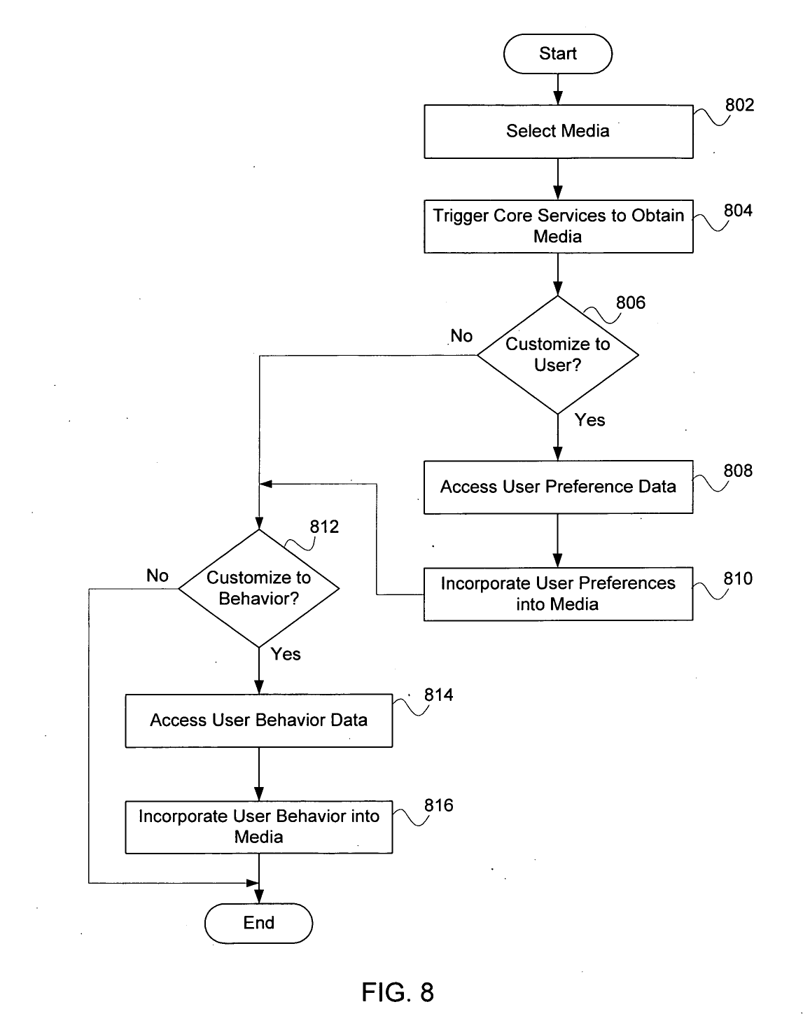

Referring now to FIG. 8, an exemplary flowchart of a method for providing a version of a dynamic media at the user computing device 300 is shown. In step 802, the user 104 selects a dynamic media. The user 104 may select the dynamic media by activating a script embedded in the HTML section of the dynamic media. Alternatively, the user 104 may drag and drop the dynamic media onto their computing device 300. Other methods of activating a link to the media provider 106 are contemplated.

In step 804, the core services module 306 at the user computing device 300 is triggered to obtain the media from the media provider. In exemplary embodiments, the selected media comprises a parent address 704 which provides access to the media provider 106 and a media identifier 708 which identifies the media. In exemplary embodiments, the core services module 306 communicates (e.g., via the messaging server 312) with the media provider 106 for further instructions.

The media provider 106 determines if the selected media should be customized to the user in step 806. Some embodiments of the dynamic media are customizable to the user 104, while other embodiments of the dynamic media are not customizable.

In step 808 user preference information is accessed if the media is customizable. In one embodiment, a customization module 604 of the media provider media engine 506 sends a request for user preference information. The user preference module 406 or the media provider data module 404 responds with the user preference information. In an alternative embodiment, the user preference information may be provided without instruction from the customization module 604 (e.g., with the initial communication/request for media from the core services module 306).

The customization module 604 then reviews the user preference information and determines appropriate data to customize the dynamic media with. For example, if the user has a preference for Spanish language media, the version of the selected media may be a Spanish version. The appropriate data to customize the dynamic media with is, in exemplary embodiments, received from a coupled database (e.g., in the database repository 112) and incorporated into the version of the dynamic media by the media module 602 in step 810.

In some embodiments, the dynamic media may be customizable based on user behavior. In step 812, the customization module 604 determines if the selected media can be customized based on past behavior. If the dynamic media is customizable to user behavior, the user behavior information is accessed in step 814. In some embodiments, user behavior information with the media provider 106 is stored by the history tracking module 606. User behavior information may also be stored at the user computing device 300 and accessed by the user preference module 406. In further embodiments, some user behavior information may also be stored with the online services server 102. User behavior may include previously selected media and media types (e.g., preference for travel and weather information for Sydney, Australia) and interactions with media and media types (e.g., purchases for a certain type of product from a certain type of media). The appropriate data to customize the media with is, in exemplary embodiments, received from a coupled database (e.g., real-time database) and incorporated into the version of the media by the media module 602 in step 816.

The method of FIG. 8 is exemplary. Alternative embodiments may comprise more or less steps, and steps may be practiced in a different order. For example, steps 812-816 may be optional, or may occur prior to, or concurrently with, steps 806-810. In a further embodiment, customization based on past behavior is a subset of the customization occurring in step 806. Thus, steps 812-816 are not required.

The above-described functions and components can be comprised of instructions that are stored on a storage medium. The instructions can be retrieved and executed by a processor. Some examples of instructions are software, program code, and firmware. Some examples of storage medium are memory devices, tape, disks, integrated circuits, and servers. The instructions are operational when executed by the processor to direct the processor to operate in accord with embodiments of the present invention. Those skilled in the art are familiar with instructions, processor(s), and storage medium.

The present invention has been described above with reference to exemplary embodiments. It will be apparent to those skilled in the art that various modifications may be made and other embodiments can be used without departing from the broader scope of the invention. Therefore, these and other variations upon the exemplary embodiments are intended to be covered by the present invention.

What is claimed is:

1. A dynamic media, comprising
a media identifier configured to identify the dynamic media; and
a parent address configured to provide contact information for a media provider of the dynamic media.

2. The dynamic media of claim 1 further comprising a HTML section comprising a script, the script configured to initiate download of a version of the dynamic media from the media provider.

3. The dynamic media of claim 1 further comprising data customized to a user's preferences.

4. The dynamic media of claim 1 further comprising data customized to a user's past behavior.

5. The dynamic media of claim 1 further comprising data utilized to generate a graphical representation of the dynamic media at a user computing device.

6. The dynamic media of claim 1 further comprising fields configured to provide customized data.

7. A computer readable medium having embodied thereon a program, the program providing instructions for a method for providing a dynamic media to a user, the method comprising:
triggering communication with a media provider to obtain the dynamic media;
requesting the dynamic media identified by a media identifier from the media provider; and
receiving the dynamic media from the media provider

8. The computer readable medium of claim 7 wherein the method further comprises customizing the dynamic media for the user.

9. The computer readable medium of claim 8 wherein the customizing is based on user preferences.

10. The computer readable medium of claim 8 wherein the customizing is based on user behavior.

11. The computer readable medium of claim 7 wherein the method further comprises providing user preference data to the media provider to customize the dynamic media.

12. The computer readable medium of claim 7 wherein the method further comprises providing user behavioral data to customize the dynamic media.

13. The computer readable medium of claim 7 wherein triggering the communication comprises activating a script embedded in a HTML section of the dynamic media.

14. The computer readable medium of claim 7 wherein triggering the communication comprises accessing and utilizing a parent address to communication with the media provider.

15. A computer readable medium having embodied thereon a program, the program providing instructions for a method for providing a dynamic media to a user, the method comprising:
receiving a drag and drop instruction for the dynamic media; and
providing the dynamic media at a designate location associated with the drag and drop instruction.

16. The computer readable medium of claim 15 wherein the method further comprises customizing the dynamic media for the user.

17. The computer readable medium of claim 16 wherein the customizing is based on user preferences.

18. The computer readable medium of claim 16 wherein the customizing is based on user behavior.

19. The computer readable medium of claim 15 wherein the method further comprises providing user preference data to a media provider to customize the dynamic media.

20. The computer readable medium of claim 15 wherein the method further comprises providing user behavioral data to a media provider to customize the dynamic media.
